(19) United States
(12) Patent Application Publication
(10) Pub. No.: US 2011/0095621 A1
(43) Pub. Date: Apr. 28, 2011

(54) Power Cord with Thermal Control

(75) Inventor: David J. Petersen, Racine, WI (US)

(73) Assignee: GARDTEC INCORPORATED, Racine, WI (US)

(21) Appl. No.: 12/710,758

(22) Filed: Feb. 23, 2010

Related U.S. Application Data
(60) Provisional application No. 61/279,467, filed on Oct. 22, 2009.

(51) Int. Cl. H01H 37/00

(52) U.S. Cl. 307/117

(57) ABSTRACT

The present invention relates to a cord for powering a cooling element including a thermally-actuated switch assembly and a method of controlling a cooling element through a power cord including a thermally-actuated switch assembly in an alternating current (AC) circuit. The cord assembly includes a multiple conductor wire for carrying power and a heat reactive element. The heat reactive element is connected in line and integral with one of the conductors of the wire. The heat reactive element functions as a switch to conduct power through the wire in one state and to interrupt power through the wire in a second state. The heat reactive element changes from one state to the other state in response to ambient air temperature.

### RELATED APPLICATION

This application claims the benefit of U.S. Provisional Application No. 61/279,467, filed Oct. 22, 2009, the entire contents of which are incorporated herein by reference.

### FIELD OF THE INVENTION

The present invention relates to cords for powering and controlling a cooling element, and in particular to such cords for powering a cooling element including thermally-actuated switch assemblies and methods of controlling a cooling element through a power cord including a thermally-actuated switch assembly in an alternating current (AC) circuit.

### BACKGROUND OF THE INVENTION

Power cords for delivering power to cooling elements have been used in various electrical devices. For example, power cords are used to power alternating current devices with such cooling elements typically including a fan or other cooling element to assist in maintaining a specific operating temperature within an environment including a housing of the device. Temperature sensing elements have also been included in such devices to sense ambient operating temperature at various locations within the device to avoid overheating of components, avoid otherwise affecting operation or avoid reducing the operating life of such electrical devices.

Various electrically powered devices require the use of cooling fans to reduce the ambient air temperature within the devices to provide efficient and continuous operation without harm to the electrical components or unintended power interruption, while extending the life of the devices and their operating components. Cooling fans are used in such devices as computers, printers, servers, modems, digital video disk (DVD) players and recorders, video players and recorders, amplifiers, powered speakers, set top boxes, internet appliances, access points, switches, manufacturing equipment, industrial controls, medical equipment, HVAC equipment, controls and cabinets, food equipment, processing equipment, factory processing and manufacturing equipment, copy machines, lighting fixtures and similar types of electrical and electronic equipment which run in various power modes. These power modes include an “on” mode where full power is provided to the device for operation, an “off” mode where the device is fully powered down and no current flows to the device, and a “standby” mode where a very small amount of current flows to the device when full power is not necessary.

In standby mode, the electrical device is not operating at full capacity and requires less power thereby reducing the ambient air temperature within the device. In this state, there is no need to power the cooling fan of the device as the ambient air temperature is below a critical temperature. When the temperature within the housing of such electrical devices is below a predetermined temperature, it would be desirable to turn the cooling fan within each such the device off to further reduce the power consumed by the device. Such operation substantially reduces overall power consumption of the devices increasing the benefit to the environment, reducing the cost of the energy to operate such devices, reducing noise from operation of the devices, and reducing the overall power demand on the power grid in a specific region.

Further, a cord is utilized to electrically connect the specified device to a power source such as an electrical outlet. Oftentimes, however, it is desirable to electrically connect the device to the power source while simultaneously having the ability to control the flow of electricity to a cooling element or fan which may be housed within or outside the device based on a change in the ambient temperature. Such previous systems have provided variable current or power controls in a direct current (DC) circuit, or have included complex DC control circuitry for complicated adjustments to the cooling element power. At least one system includes a thermostatically controlled circuit between the power source and the device. Such systems typically include a thermostat mounted to the device itself or a thermostatic circuit within the device to vary power thereto. Such a system can often be complicated in requiring multiple electronic components, cumbersome in size, taking up valuable interior space within the housing of the electrical device, costly to manufacture and difficult to assemble and maintain. It would be desirable to overcome these shortcomings and include a temperature sensing element in line and integrated with one conductor of the power cord to switch a cooling element on and off to control the ambient temperature surrounding the cooling element while conserving energy and reducing operating costs.

Accordingly, it would be beneficial to provide a power cord with thermal control that reduces the amount of electricity consumed by powered machinery and equipment. Such a device and method of operation would ease the environmental impact and decrease the cost associated with operating such machinery and equipment in a convenient and cost effective manner. It would be advantageous to reduce the carbon foot print of such electrically powered devices as well as reduce the amount of noise emanating from such equipment while it is powered on in standby mode or in other states of reduced electrical consumption as required by the demands of modern day business, machinery and electronics including computer networks, data storage facilities, the world wide web and similar business environments.

### SUMMARY OF THE INVENTION

According to the present invention, a cord for powering a cooling element with thermal control is provided which is simple in design and in use substantially reduces energy consumption in cooling electrical and electronic devices in a cost effective manner. The power cord with thermal control includes a multiple conductor wire for carrying power and a heat reactive element placed in line of one of the conductors of the wire. The heat reactive element functions as a switch to conduct power through the wire in one state and to interrupt power through the wire in a second state. In a preferred embodiment, the wire is a two or three conductor wire which carries an alternating current signal and the heat reactive element is a thermistor. In another preferred embodiment the heat reactive element is a bi-metal thermistor. In yet another preferred embodiment the heat reactive element is thermistor which opens at a predetermined temperature or closes at a predetermined temperature, or a thermistor which opens at a first temperature and then closes at a second temperature.

Another preferred embodiment includes a power cord for powering a cooling element having a heat reactive element that functions as a switch to conduct a current of up to 5 Amperes through the wire in one state and to interrupt power through the wire in a second state. The current is preferably an alternating current.

In another preferred embodiment, the power cord for powering a cooling element includes a heat reactive element which switches from one state to another at a predetermined temperature, and preferably from one state to another within a range of approximately 10 percent (10%) of the predetermined temperature. In yet another embodiment, the heat reactive element changes state within a range of approximately 2 degrees Celsius to approximately 3 degrees Celsius, or 2 degrees Celsius to approximately 5 degrees Celsius, from the predetermined temperature. In another preferred embodiment, the predetermined temperature is approximately 25 degrees Celsius to approximately 35 degrees Celsius, and more preferably approximately 30 degrees Celsius.

In another preferred embodiment, the cord for powering a cooling element includes a cooling fan being switched by said the heat reactive element between a conducting state and an open state. In yet another preferred embodiment, a series of 2 fans up to a series of 10 fans are switched by the power cord through the heat reactive element.

Another preferred embodiment includes a method of controlling a cooling element through a power cord in an alternating circuit including the steps of providing a multiple conductor wire for carrying alternating current to the cooling element, providing a heat reactive element placed in line of one of the conductors of the wire, and switching the heat reactive element between one state where alternating current is conducted through the power cord and a second state where alternating current is interrupted through the power cord. The switching of the heat reactive element from the first state to the second state takes place at a predetermined temperature.

Another preferred embodiment includes a method in which the state where alternating current is conducted through the power cord is the closed state of said heat reactive element which occurs at a temperature of approximately 30 degrees Celsius. Another preferred embodiment provides a method where the step of switching the heat reactive element between one state and a second state includes switching between one state and the second state within a range of approximately ten percent (10%) from the predetermined temperature. In yet another embodiment, the step of switching the heat reactive element from one state to a second state occurs between approximately 2 degrees Celsius to approximately 5 degrees Celsius from a predetermined temperature. Yet another preferred embodiment includes a method where the step of switching the heat reactive element between one state and a second state switches a cooling element, preferably a cooling fan, on and off. Another preferred embodiment includes the step of switching the heat reactive element between one state and a second state switches at least two (2) cooling fans, and more preferably between two (2) and ten (10) cooling fans, on and off simultaneously.

### BRIEF DESCRIPTION OF THE DRAWINGS

Preferred embodiments of the present invention will now be described, by way of example with reference to the accompanying drawings, in which:

FIG. 1 is a perspective view of a power cord with thermal control in accordance with the present invention;

FIG. 2 is a detailed view of the thermal control switch of the power cord of FIG. 1;

FIG. 3 illustrates the power cord of shown in FIG. 1 in use for powering cooling elements;

FIG. 4A is a top view of a “T” connector for use with the power cord of FIG. 1;

FIG. 4B is a top view of a “L” or 90-degree connector for use with the power cord of FIG. 1;

FIG. 4C is a top view of a “J” or 45-degree connector for use with the power cord of FIG. 1;

FIG. 4D is a top view of a “I” or straight connector for use with the power cord of FIG. 1;

FIG. 4E is a top view of a lug connector for use with the power cord of FIG. 1;

FIG. 4F is a top view of a typical AC or “2-prong” connector for use with the power cord of FIG. 1; and

FIG. 5 is a flow chart showing the operation of an embodiment of the power cord illustrated in FIG. 1.

### DETAILED DESCRIPTION

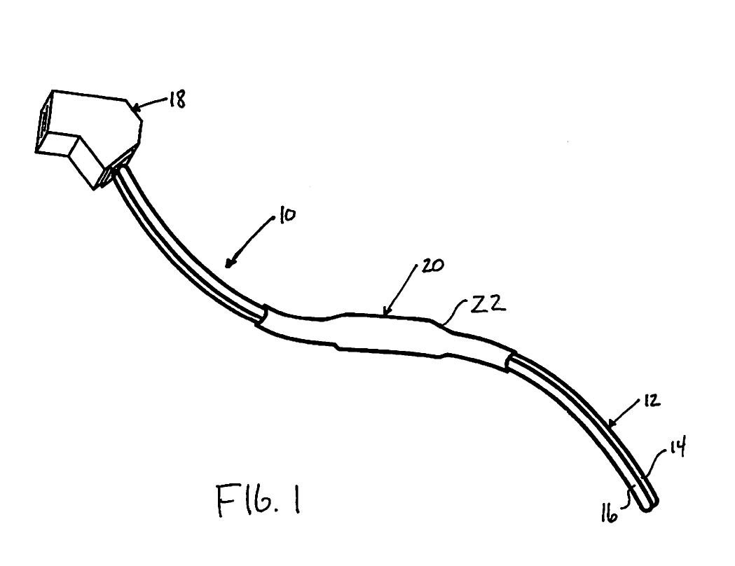

Referring to FIG. 1, the illustrated power cord with thermal control 10 comprises a wire 12 having multiple conductors, and as illustrated in one preferred embodiment, two conductors 14, 16 with connector 18 at one end. A heat reactive or thermal element 20 is connected to one of the multiple conductors, as shown in FIG. 1, conductors 14, 16, and surrounded by shrink tubing 22 to attach thermal element 20 to the power cord 10 as shown. As can be seen in one preferred embodiment of FIG. 1, thermal element 20 is axially aligned and integral with wire 12 and conductors 14, 16 of power cord 10 to provide flexibility thereby preventing restriction in movement of power cord 10, including wire 12. Thermal element 20 is configured and positioned on wire 12 to be placed within a housing of an electrical device to detect or read ambient temperature within the housing.

The cost of energy continues to rise throughout the world. The average cost of electricity in the United States is over $0.102 per kilowatt (kWh). United States government estimates indicate that the cost of electricity will rise by as much as 35 percent by 2030. As electricity costs escalate, more organizations and consumers will search for ways to reduce consumption of electricity to save money and save the environment. As an example, the average cost of electricity in 1970 was $0.017 per kWh. This equates to an over 700 percent rise in the cost of electricity by the year 2030. Reduction of the use of energy in a significantly wide spread manner through application to virtually all electrical appliances and machinery with cooling fans is achieved by the use of the power cord of the present invention.

One example of the energy savings which is achieved by the present power cord with thermal control is in worldwide use of computers, peripherals and similar business equipment. A majority of the workers in the United States, United Kingdom and Germany use computers, printers, peripherals and similar business equipment regularly each day in their employment. This equates to approximately 74 percent of the work force in the United States, or approximately 108 million workers; 78 percent of the workforce in the United Kingdom, or 17 million workers; and 79 percent of the workforce in Germany, or 31 million workers. According to a study conducted in October 2008, over 50 percent of the workers employed throughout the world who use a computer at work generally do not shut down their computer at the end of the work day.

Such energy and electricity waste is increasing as the demand for remote access and server technology increases making it is necessary to keep the computers running to provide remote access when needed. Without energy conservation measures in place, companies across the United States are wasting $2.8 billion in energy and emitting over 20 million tons of carbon dioxide into the environment. This estimate is based on a conservative approximation of a computer being on 14.5 hours each night and 48 hours over each the weekend. Such estimate equates to a single company having 10,000 computers wasting over $260,000.00 annually according to a study done by Climate Savers Computing in 2009. The power cord with thermal control including a heat reactive element addresses these worldwide concerns by eliminating this very significant energy waste.

Power cord 10 with integral thermal control being simple in design and cost effective to manufacture solves these deficiencies and provides significant energy and cost savings in controlling cooling elements in electrical devices as described herein. Specifically, power cord 10 is connected to a cooling element, typically a cooling fan or similar cooling device. Power cord 10 operates to control the cooling device in conjunction with thermal element 20 such that thermal element 20 has two states, namely closed and open.

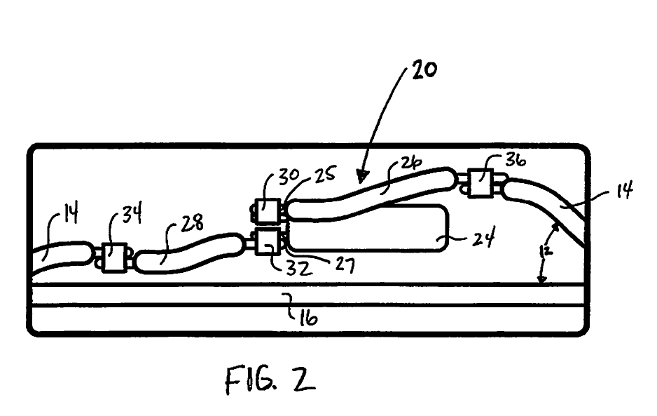

A typical detailed connection of thermal element 20 is illustrated in the preferred embodiment of FIG. 2. As can be seen, thermal element 20 includes a thermistor 24 having connection leads 25, 27 which are connected in line to either side of conductor 14. The details of the connection include lead wires 26, 28 connected to connection leads 25, 27 with band connectors 30, 32. Lead wires 26, 28 are connected to either end of conductor 14 by band connectors 34, 36. Conductor 16 remains in tact and un-severed while thermistor 24 is connected in-line of one of the multiple connectors, and as shown in the preferred embodiment of FIG. 1, connector 14. It will be appreciated by those skilled in the art that anyone of the connectors could include the heat reactive or thermal element 20 or thermistor 24 as long as the current in wire 12 is interrupted when required and restored when the thermal element 20 or thermistor 24 closes. This preferred in-line connection provides placement of thermistor 24 along the axis of wire 12. Axial placement in this manner integrates thermistor 24 into wire 12 thereby creating a complete unit with a very compact design having a uniquely small foot print which is very cost effective to manufacture. Thermistor 24 has a “closed” and an “open” position allowing the electrical current through power cord 10 to be switched between an “on” state and an “off” state.

Thermistor 24 may be of a variety of types. A thermistor is a thermally sensitive resistor made from semiconducting ceramic material produced from metal oxide. One preferred configuration is a snap type, bi-metal temperature sensing thermistor which includes a resin body having nominal dimensions such that the thermistor 24 may be readily and easily placed in line and axially integrated with one of the multiple conductors of wire 12, specifically either conductor 14 or 16, as illustrated in the preferred embodiment of FIG. 1. It is preferred that the thermistor 24 be positioned such the it is connected and placed linearly and in-line, axially along one of the conductors of wire 12. In this configuration, thermistor 24 can be integral with wire 12 and covered with heat-shrink tubing, non-conductive flexible tape, insulation and the like, or similar covering material to protect the thermistor and finish wire 12 of power cord 10.

A snap type, bi-metal thermistor includes two distinct operating states, one being an “on” or closed state in which current is conducted through the thermistor. In a second operating state, the “off” or open state, no current is conducted through the thermistor. Such snap type, bi-metal thermistors have an action temperature in which the state of the thermistor is changed. The action temperature varies based on the desired temperature control and has a tolerance that may range from 3% up to 20% according to the application in which the thermistor and power cord are being used. In addition, the thermistor may include a reset temperature under or over which the ambient temperature must fall below or rise to before the thermistor is reset to change state at the action temperature plus or minus the thermistor's tolerance. Depending on the application and use of the thermistor, the reset temperature may be zero (0) to a percent of the operating range of the thermistor. Accordingly, thermistor 24 will change state at the action temperature plus or minus the tolerance of the device (specifically 3% to 20% range of variance, as described above) after the reset temperature has been reached. Such specific design specifications of thermistor 24 are those of preferred embodiments of the present invention, several of which are described herein.

In operation, thermistor 24 detects the ambient air temperature surrounding the thermistor. Typically the ambient air temperature in the housing of an electrical device surrounding thermistor 24 will reach an equilibrium with the temperature of the metal switch contacts of the bi-metal thermistor 24. The rate of change of the temperature between the ambient air and the temperature of the metal contacts of thermistor 24 determines the open (off state) and closed (on state) operation of the thermistor and the repeatability of closing and opening of the contacts of thermistor 24 at predetermined temperatures. When the air is mixed and begins to heat around the thermistor 24, the contacts of thermistor 24 begin to heat as well. When the thermistor contacts begin to heat, they begin to soak up heat from the ambient air and they begin their closing movement. When the ambient air surrounding thermistor 24 begins to heat, the heat penetrates the body of thermistor 24 (the soaking process) and warms the metallic contacts within the thermistor. The temperature around the outside of the thermistor may be higher than the predetermined closing temperature as it takes some time to allow the heat to penetrate into the metallic contacts—known as “thermal lag.” This is particularly true when the case is made of plastic material, which is the material of choice for many currently available thermistors. The faster the temperature rises and the larger the total temperature difference from the beginning of the heating cycle to the specified operating temperature, the more thermal lag will be experienced.

The differential or hysteresis in a thermistor is the difference in temperature, measured in degrees Celsius, between the point where thermistor 24 first operates (opens or closes) and the level where the metallic contacts return to their original state (the opposite of the first operation). Large hysteresis provides a significant amount of cooling prior to resetting thus eliminating the repetitive cycling on and off or hunting that may damage electronic equipment, particularly if such takes place at high operating temperatures. It may take up to 1 to 2 hours for the contacts of thermistor 24 to cool down such that the reset temperature (as described below) can be achieved. Once the reset temperature is achieved, thermistor 24 is activated so that reaching the predetermined temperature will cause thermistor to change state from open to closed, or from closed to open. This type of operation prevents hunting in which the thermistor may open and close is rapid succession. Hunting is an undesirable operating condition which is typically avoided in the design and use of the power cord with thermal control described herein.

Specifically, thermistor 24 in one preferred embodiment is a snap action, bimetal, two state thermistor. A snap action thermistor typically includes a bimetallic disc which is designed and formed to hold its original shape until the predetermined transition temperature is reached. At the predetermined transition or action temperature, the thermistor switches the position of the contacts quickly (by “snap action”). In one preferred embodiment, thermistor 24 has an action temperature of approximately 30 degrees Celsius (85 degrees Fahrenheit) with a tolerance of 10 percent (10%) (approximately 3 degrees Celsius or approximately 8.5 degrees Fahrenheit) with a current handling capacity of up to 5 Amperes. More specifically, in preferred embodiments, thermistor 24 may operate at a temperature range of 25 to 30 degrees Celsius (77 to 86 degrees Fahrenheit) or from 25 to 35 degrees Celsius (77 to 95 degrees Fahrenheit). In another preferred embodiment, thermistor 24 will remain open and not conducting current to the cooling element when the measured ambient temperature is below approximately 28.5 degrees Celsius (approximately 83.3 degrees Fahrenheit) plus or minus ten percent or approximately 3 degrees Celsius (8.5 degrees Fahrenheit). In a further preferred embodiment, thermistor 24 will close and begin conducting current through wire 12 to power the cooling element when the measured ambient temperature is above approximately 31.6 degrees Celsius (approximately 88.8 degrees Fahrenheit) plus or minus ten percent or approximately 3 degrees Celsius (8.5 degrees Fahrenheit).

In other preferred embodiments, thermistor 24 operates to switch between 2 to 5 Amperes of alternating current. Such thermistors are available through various electronic component manufacturers in the United States, Canada and Asia.

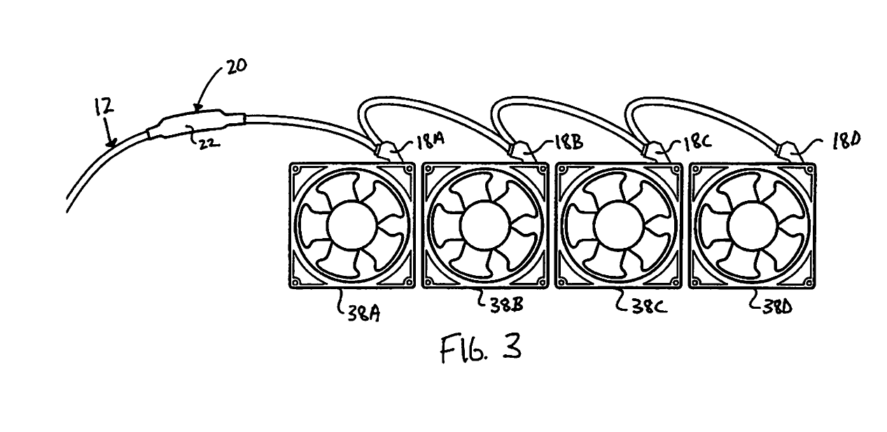

FIG. 3 illustrates another preferred embodiment of the power cord with thermal control of the present invention. Wire 12 includes thermal element 20, preferably a thermistor as described above, connected in line, integrated with wire 12 and covered by shrink tubing 22 having multiple connectors 18A, 18B, 18C, 18D connected to multiple cooling fans 38A, 38B, 38C, 38D in a daisy chained configuration. In another preferred embodiment, it is contemplated that up to ten (10) cooling fans 38 may be electrically connected in series using one power cord 10 having up to ten connectors such as connector 18. A single thermal element 20, preferably thermistor 24, controls the “on” state and “off” state of cooling fans 38 in unison. Such a daisy chain configuration of fans allows cooling as desired for specific electronic devices and heavy duty electrically operated alternating current equipment as is described in detail below.

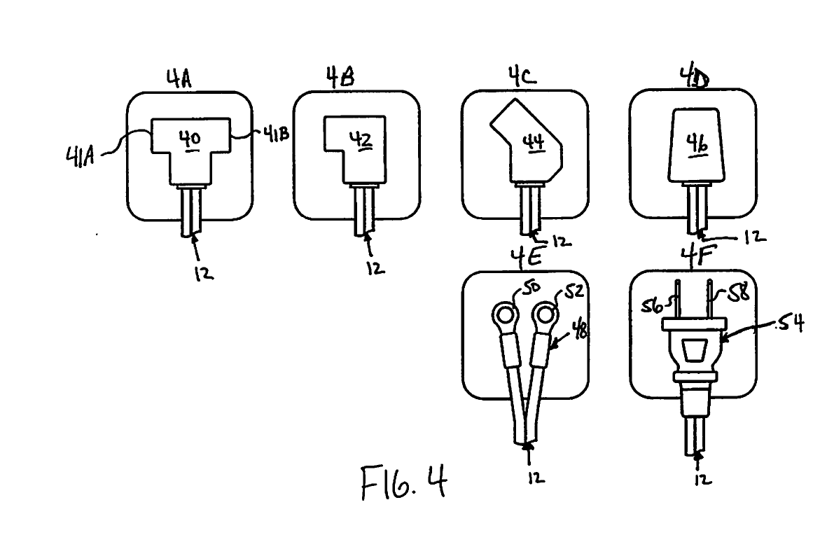

FIG. 4 illustrates the various connectors which may be utilized with the power control cord with thermal control therein. Connector 40 includes a “T” connector and is shown in FIG. 4A. The “T” connector includes two connection points 41A and 41B on either side of “T” connector 40. In FIG. 4B, an “L” connector 42 is shown. Such an “L” shaped connector 42 is also known as a “90-degree” connector as the plug interface bends 90 degrees to the plane extending down wire 12. FIG. 4C illustrates a “J” connector 44, as the connector body forms a general shape of the letter “J.” Such a “J” shaped connector is also known as a “45-degree” connector as the plug interface bends 45 degrees to the plane extending down wire 12. Connector 46 shown in FIG. 4D illustrates a straight connector as the plug extends down wire 12 in the same plane as wire 12. Lug connector 48 is illustrated in FIG. 4E and includes lugs 50, 50 connected at one end of wire 12. FIG. 4E illustrates a standard alternating current (AC) plug 54 having two blades 56, 58 at one end thereof. The connectors of FIGS. 4A-4F may be used in various configurations, including the daisy chain configuration illustrated in FIG. 3, to provide connection of power cord 10 with thermal control to one or more cooling elements, including cooling fans 38 as illustrated. Such connection provides the control of thermal element 20, preferably thermistor 24, as illustrated in FIGS. 1, 2 and 3.

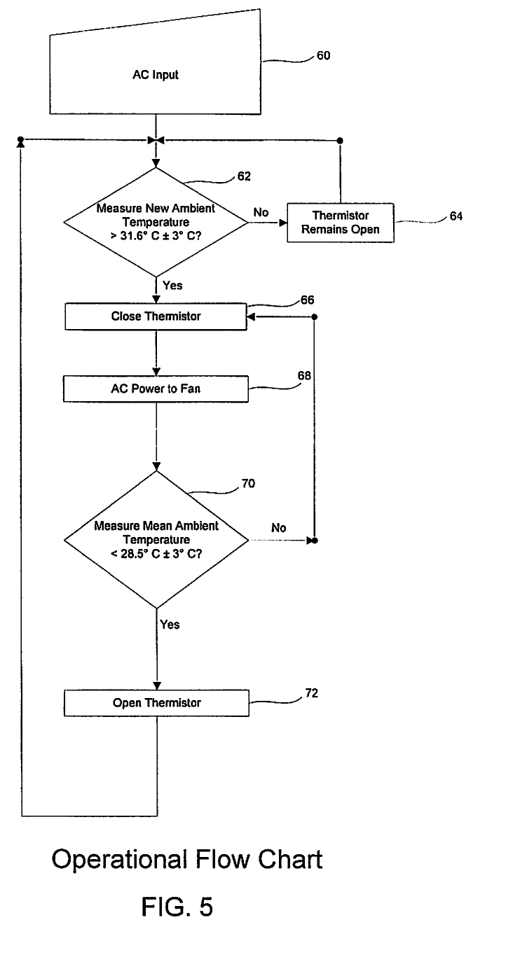

The operation of the power cord with thermal control of the present invention will be better understood from the following discussion taken together with the drawings. FIG. 5 depicts a flow diagram showing the method of operation of the power card with thermal control of the present invention. Alternating current (AC) input is provided at step 60. At step 62 the ambient temperature at a desired location is measured. If the newly measured ambient temperature is less than approximately 31.6 degrees Celsius (approximately 88.8 degrees Fahrenheit), thermal element 20, or preferably thermistor 24, remains in its open state so that no current flows through the thermal element or thermistor and the cooling element remains off. If the measured ambient temperature is greater than approximately 31.6 degrees Celsius the thermal element 20, preferably thermistor 24, closes at step 66 such that AC power is applied to the cooling element, preferably fan 38, at step 66 to allow the ambient temperature within the electrical device to be lowered. At step 70 the ambient temperature continues to be measured and monitored. If the ambient temperature is over approximately 28.5 degrees Celsius, thermal element 20, preferably thermistor 24, remains closed and the cooling element, namely fan 38, remains in an “on” state to continue cooling the target area in the electrical device.

At step 70, the mean ambient temperature continues to be measured and monitored. If the ambient temperature falls below the desired temperature, in this preferred embodiment, 28.5 Celsius plus or minus 10 percent (approximately 3 degrees Celsius) or from approximately 25.5 degrees Celsius to approximately 31.5 degrees Celsius, then thermal element 20, preferably thermistor 24, opens. In this state, AC current flow to the cooling element of fan 38 is stopped. The process continues at step 62 where the ambient temperature continues to be measured and monitored. The process continues as described above until AC power is removed from the electrical device. In this manner, the cooling elements or cooling fans of an electrical device are only used to reduce the ambient temperature of the interior of the device only when need and specifically only when the temperature is at a level that may cause harm to the electronic components of the device. Such conservation of energy will reduce the overall power consumption of such devices by a significant amount contributing to the “green” affect of such devices when used.

The term “cooling element” includes any type of cooling device used in electrical equipment and may include cooling fans, cooling compressors, heat pumps, blowers, and the like. The term “thermal element” includes any type of thermal element that reacts between two states to control current through a circuit. Such “thermal element” includes any type of thermistor, thermal protector or control thermostat, and may include snap thermistors, creep thermistors, positive temperature coefficient thermistors, negative temperature coefficient thermistors, high accuracy and high resistance thermistors, high-precision thermal sensing thermistors, ultra-thin thermistors, axial lead diode type thermistors, thin film thermistors, chip thermistors, thermopiles, non-contact thermal sensors, bi-metallic switches, temperature sensors, heat reactive circuits and similar temperature sensing elements depending on the application and design necessary to achieve the desired operation.

In addition, while specific component values have been shown for ease of illustration and description, it should be understood that a variety of combination of values is possible and contemplated by the embodiments of the invention. Further, while specific connections have been used and shown for ease of description, it should also be understood that a variety of connection points are possible and may vary depending on the specifics of the application and circuit used.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The embodiments of the present invention herein described and disclosed are presented merely as examples of the invention. Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention. Other embodiments, forms and structures coming within the scope of this invention will readily suggest themselves to those skilled in the art, and shall be deemed to come within the spirit and scope of the invention.

What is claimed is:

1. A cord for powering a cooling element comprising:
a multiple conductor wire for conducting current; and
a heat reactive element placed in line of one of the conductors of the wire which functions as a switch to conduct current through the wire in one state and to interrupt current through the wire in a second state.

2. The cord for powering a cooling element of claim 1 wherein the wire for carrying power carries an alternating current signal.

3. The cord for powering a cooling element of claim 1 wherein the heat reactive element is a thermistor.

4. The cord for powering a cooling element of claim 1 wherein the heat reactive element is a bi-metal thermistor.

5. The cord for powering a cooling element of claim 1 wherein the heat reactive element is a thermistor which opens at a predetermined temperature.

6. The cord for powering a cooling element of claim 1 wherein the heat reactive element is a thermistor which closes at a predetermined temperature.

7. The cord for powering a cooling element of claim 1 wherein the heat reactive element is a thermistor which opens at a first temperature and closes at second temperature.

8. The cord for powering a cooling element of claim 1 wherein the heat reactive element functions as a switch to conduct a current of up to approximately 5 Amperes through the wire in one state and to interrupt the current through the wire in a second state.

9. The cord for powering a cooling element of claim 1 wherein the heat reactive element functions as a switch to conduct an alternating current of approximately 5 Amperes through the wire in one state and to interrupt current through the wire in a second state.

10. The cord for powering a cooling element of claim 9 wherein the heat reactive element functions as a switch to conduct an alternating current of approximately 2 Amperes to approximately 5 Amperes.

11. The cord for powering a cooling element of claim 9 wherein the heat reactive element functions as a switch to conduct an alternating current of approximately 2 Amperes to approximately 3 Amperes.

12. The cord for powering a cooling element of claim 1 wherein the heat reactive element switches from one state to another at a predetermined temperature.

13. The cord for powering a cooling element of claim 12 wherein the heat reactive element switches from one state to another within a range of approximately 10 percent from the predetermined temperature.

14. The cord for powering a cooling element of claim 12 wherein the heat reactive element switches from one state to another within a range of approximately 2 degrees Celsius to approximately 5 degrees Celsius from the predetermined temperature.

15. The cord for powering a cooling element of claim 12 wherein the predetermined temperature is approximately 30 degrees Celsius.

16. The cord for powering a cooling element of claim 12 wherein the predetermined temperature is in a range of approximately 25 degrees Celsius to approximately 35 degrees Celsius.

17. The cord for powering a cooling element of claim 1 including a cooling fan being switched by said the heat reactive element between an “on” state and an “off” state.

18. A power cord assembly comprising:
a multiple conductor wire for carrying power;
a heat reactive element placed in line of one of the conductors of the wire which functions as a switch to conduct power through the wire in one state and to interrupt power through the wire in a second state; and
a cooling element connected to the multiple conductor wire which is switched on when the heat reactive element is in said one state and switched off when the heat reactive element is in said second state in response to a change in ambient temperature.

19. The power cord assembly of claim 18 wherein said cooling element further comprises a cooling fan.

20. The power cord assembly of claim 19 wherein said cooling fan further comprises 2 to 10 cooling fans connected to said multiple conductor wire in series.

21. A method of controlling a cooling element through a power cord in an alternating circuit comprising the steps of:
providing a multiple conductor wire for carrying alternating current to the cooling element;
providing a heat reactive element placed in line of one of the conductors of the wire;
switching the heat reactive element between a first state where alternating current is conducted through the power cord and a second state where alternating current is interrupted through the power cord in response to the ambient temperature.

22. The method of claim 21 wherein said first state where alternating current is conducted through the power cord is a closed state of said heat reactive element which occurs at a predetermined temperature.

23. The method of claim 21 wherein the step of switching the heat reactive element between said first state and said second state includes switching between said first state and said second state within a range of approximately 10 percent from a predetermined temperature.

24. The method of claim 21 wherein the step of switching the heat reactive element between said first state and said second state switches a cooling fan on and off.

25. The method of claim 21 wherein the step of switching the heat reactive element between said first state and said second state switches at least 2 cooling fans on and off simultaneously.

26. The method of claim 21 wherein the step of switching the heat reactive element between said first state and said second state switches between 2 to 10 cooling fans on and off simultaneously.

27. The method of claim 21 wherein the step of switching the heat reactive element between said first state and said second state switches between 2 to 10 cooling fans connected in series on and off simultaneously.
